(19) United States
(12) Patent Application Publication
(10) Pub. No.: US 2009/0193187 A1
(43) Pub. Date: Jul. 30, 2009

(54) DESIGN STRUCTURE FOR AN EMBEDDED DRAM HAVING MULTI-USE REFRESH CYCLES

(75) Inventors: John E. Barth, Jr., Williston, VT (US); Philip G. Emma, Danbury, CT (US); Hillery C. Hunter, Somers, NY (US); Vijayalakshmi Srinivasan, New York, NY (US); Arnold S. Tran, South Burlington, VT (US)

Correspondence Address: HOFFMAN WARNICK LLC, 75 STATE ST, 14TH FLOOR, ALBANY, NY, 12207, US

(73) Assignee: International Business Machines Corporation, Armonk, NY (US)

(21) Appl. No.: 12/103,290

(22) Filed: Apr. 15, 2008

Related U.S. Application Data
(63) Continuation-in-part of application No. 12/019,818, filed on Jan. 25, 2008.

(51) Int. Cl. G06F 12/00

(52) U.S. Cl. 711/106; 711/E12.001

(57) ABSTRACT

A design structure for an embedded DRAM (eDRAM) having multi-use refresh cycles is described. In one embodiment, there is a multi-level cache memory system that comprises a pending write queue configured to receive pending prefetch operations from at least one of the levels of cache. A prefetch queue is configured to receive prefetch operations for at least one of the levels of cache. A refresh controller is configured to determine addresses within each level of cache that are due for a refresh. The refresh controller is configured to assert a refresh write-in signal to write data supplied from the pending write queue specified for an address due for a refresh rather than refresh existing data. The refresh controller asserts the refresh write-in signal in response to a determination that there is pending data to supply to the address specified to have the refresh. The refresh controller is further configured to assert a refresh read-out signal to send refreshed data to the prefetch queue of a higher level of cache as a prefetch operation in response to a determination that the refreshed data is useful.

### CROSS-REFERENCE TO RELATED APPLICATIONS

This patent application is a continuation-in-part of U.S. patent application Ser. No. 12/019,818, filed Jan. 25, 2008.

### BACKGROUND

This disclosure relates generally to integrated circuit design, and more specifically to a design structure for an embedded DRAM (eDRAM) cache having multi-use refresh cycles.

An eDRAM cache is a memory storage technology that is based on dynamic memory cells that lose their charge over time and as a result lose existing data if the charge is not restored through a refresh operation. In a typical refresh operation, existing data of a word line within a data array is locally read and written back into all cells along a word line. During refresh, the data is not normally driven out of the data array. The act of performing a refresh operation in an eDRAM cache costs power, i.e., results in power consumption. Because the eDRAM cache is in use with a microprocessor, power consumption is an issue when performing refresh operations.

### SUMMARY

In one embodiment, there is a design structure embodied in a machine readable medium used in a design process. In this embodiment, the design structure comprises a pending write queue configured to receive write operations from at least one of the levels of cache. A refresh controller is configured to determine addresses within the cache that are due for a refresh. The refresh controller is configured to assert a refresh write-in signal to write data supplied from the pending write queue specified for an address due for a refresh rather than refresh existing data. The refresh controller asserts the refresh write-in signal in response to a determination that there is pending data to supply to the address specified to have the refresh. The refresh controller is further configured to assert a refresh read-out signal to send refreshed data to a prefetch queue of a higher level of cache as a prefetch operation in response to a determination that the refreshed data is useful.

### BRIEF DESCRIPTION OF THE DRAWINGS

FIG. 1 is a schematic diagram of a computer system having a multi-level cache memory system according to one embodiment of this disclosure;

FIG. 2 is a more detailed view of the level two (L2) cache of the multi-level cache memory system shown in FIG. 1;

FIG. 3 is a flow chart describing a process of performing a refresh operation with the multi-level cache memory system shown in FIG. 1 according to one embodiment of this disclosure; and

FIG. 4 shows a flow diagram describing a design process that can be used in the semiconductor design, manufacturing and/or test of the design structure embodied in this disclosure.

### DETAILED DESCRIPTION

Embodiments of this disclosure are directed to a design structure for a multi-level cache memory system that uses an eDRAM cache that can perform refresh operations in a way that efficiently uses power such that power consumption is minimized. In particular, the multi-level cache memory system of this disclosure recognizes that the power consumption of a refresh operation is dominated by the sensing of the existing data values that are to be refreshed, so the power consumption that occurs at the local subarray of the eDRAM macro (i.e., the data array) is similar to the power consumption that occurs through a standard read operation. Because part of the power cost of a read or write access is paid during a refresh operation, the inventors to this disclosure have provided a multi-level cache memory system that refreshes by writing in useful data rather than just restoring existing data and if no useful data is available, uses the data read during the refresh operation in a productive manner within the system (i.e., move it to a higher level of cache for efficient use). Power consumption is therefore minimized because unnecessary read and write operations are avoided and useful data is efficiently moved to higher levels of the cache, avoiding unnecessary reads of the lower levels of the cache.

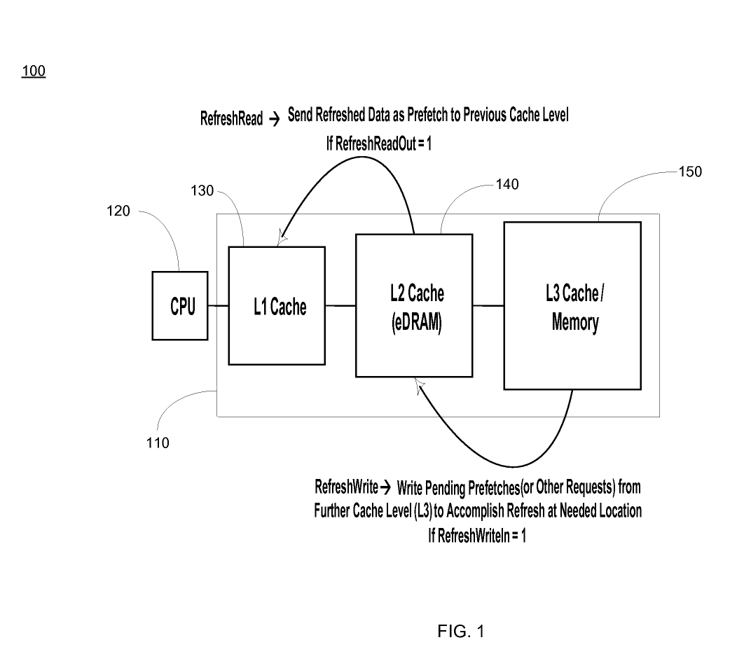

FIG. 1 is a schematic diagram of a computer system 100 having a multi-level cache memory system 110 according to one embodiment of this disclosure. The computer system comprises a central processing unit (CPU) 120 and a multi-level cache memory 130 coupled to the CPU. The CPU 120 communicates directly with a level one (L1) cache 130, which communicates directly with a level two (L2) cache 140, which communicates directly with a level three (L3) cache 150. As shown in FIG. 1, the L3 cache 150 may be main memory. The L1 cache 130 is physically smaller than the L2 cache 140 and L3 cache 150 and is located closer to the CPU 120 in order to shorten transmission of data. The L2 cache 140 is physically larger than the L1 cache 130 but smaller than the L3 cache 150.

Because the CPU 120 communicates directly with the L1 cache 130, it will read and write data out of the L1 cache. Since the L1 cache 130 is located closer to the CPU 120 and smaller than the other cache levels, the communications are quicker. Essentially, the L2 cache 140 and the L3 cache 150 serve as backup to the L1 cache 130. If the L1 cache 130 does not have the data that the CPU 120 wants, then the CPU tries to find the data in the L2 cache 140, and if the data is not in the L2 cache, then the CPU looks to the L3 cache 150. If the data is not in the L3 cache 150, then the main memory is searched.

The L2 cache 140 as shown in FIG. 1 comprises an eDRAM. The L2 eDRAM cache 140 performs refresh operations in a way that efficiently uses power such that power consumption is minimized. In particular, the L2 cache 140 uses a refresh write-in signal that causes the eDRAM cache to determine if there is pending write data in a pending write queue that is to be supplied to the word line in the L2 cache that is scheduled for a refresh operation. If there is pending write data in a pending write queue that is to be supplied from either the L3 cache 150 or the L1 cache 130, then the L2 cache 140 asserts the refresh write-in signal causing the pending write data to be supplied to the word line instead of having the refresh operation performed on the existing data. This reduces power consumption because the refresh operation which would read and write the existing data would incur an unnecessary power cost since this refreshed data for the word line is going to be rewritten with data supplied from the pending write queue.

Another aspect in which the L2 cache 140 can minimize power consumption during a refresh operation is by using a refresh read-out signal that causes the eDRAM cache to send refreshed data to a higher level cache (i.e., L1) if it is useful, i.e., the data can be used in a productive way in the future. In particular, if the data is useful to the L1 cache 130 (or to some other part of the system), then the L2 cache 140 asserts the refresh read-out signal, causing the refreshed data to be supplied to the word line that finds the data useful, i.e., can be used productively for example in another future operation. This reduces power consumption because the cost of transferring refreshed data to a higher level cache is minimal compared to the cost of simply forwarding the data after it was read during the refresh operation. In particular, the majority of the power cost has already been paid during the refresh operation, and thus the power cost incurred for the total operation is minimal.

Those skilled in the art will recognize that the multi-level cache memory system can take on other configurations than the one shown in FIG. 1. In particular, there can be more or less cache levels within the system. Furthermore, the use of the eDRAM cache is not limited to use in the L2 cache. In particular, those skilled in the art will recognize that the eDRAM cache can be used in some or all of the different levels of the multi-level cache memory system. However, the functionality of the eDRAM cache in each level will depend on where it is situated within the hierarchy of the levels of the cache. For example, if the eDRAM cache is located in the L1 cache, then the refresh controller in this cache would only assert a refresh write-in signal and not a refresh read-out signal because the L1 cache is only getting pending data and prefetched data from the L2 cache. If the eDRAM cache is located in the L3 cache, then the refresh controller in this cache would only assert a refresh read-out signal and not a refresh write-in signal because the L3 cache is only sending pending data and pending prefetches to the L2 cache (unless prefetch occurs from memory).

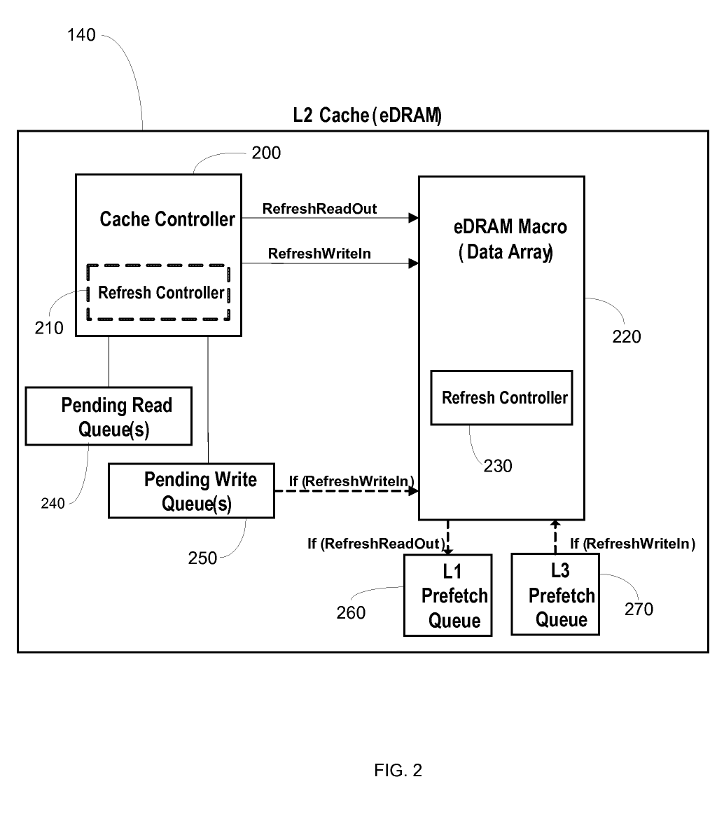

FIG. 2 is a more detailed view of the L2 cache 140 (eDRAM) of the multi-level cache memory system 100 shown in FIG. 1. The L2 cache 140 comprises a cache controller 200 that uses circuitry (not shown) to perform various operations (e.g., refresh) and data requests (e.g., read, write, prefetch, etc). A refresh controller 210 facilitates the above-described functions associated with asserting the refresh write-in signal and the refresh read-out signal during the refresh operation of data in the eDRAM macro 220 which is the data array containing word lines of data and instructions. The eDRAM macro 220 in FIG. 2 is also shown with a refresh controller 230 to facilitate the functions associated with asserting the refresh write-in signal and the refresh read-out signal during the refresh operation. In one embodiment, the refresh controller 210 in the cache controller 200 is a copy of the refresh controller 230 in the macro 220.

The L2 cache 140 further comprises pending read queue(s) 240 and pending write queue(s) 250. The pending read queue(s) 240 contain data read requests that are pending to be read from the L2 cache. The pending write queue(s) 250 contain data that is pending to be written into the L2 cache 140. In one embodiment, the pending write queue(s) 250 writes data to the macro if the refresh write-in signal has been enabled. An enabled refresh write-in signal is an indication that there is pending data that is ready to be supplied to the macro.

The refresh controller 230 checks the entries that are in an L1 prefetch queue 260 and an L3 prefetch queue 270. Each prefetch queue contains requests for data that the system 110 has predicted to be requested by a specific level cache at a time later in the future. Essentially, the prefetches are advanced requests that are sitting in prefetch queues that are likely needed by the system 110 in the future but are not processed right away because they might interfere with regular requests that are currently in process. In FIG. 2, the L1 prefetch queue 260 contains data that is likely needed by the L1 cache 130 in the future, while the L3 prefetch queue 270 contains data that is likely needed by the L2 cache, and has been sent to the L2 cache by the L3 cache. Data transfers from the macro 220 to the L1 prefetch queue 260 when the refresh read-out signal is enabled, and similarly, data transfers from the L3 prefetch queue to the macro when the refresh write-in signal is enabled.

From a power perspective, prefetches are usually an issue because a prefetch is a prediction that might not be correct. As a result, the disclosure has provided an approach that performs prefetches in times that will not cost much in power and performance. Refresh operations are one such instance where prefetches can be performed without costing much in power and performance. For example, if the system 110 is scheduled to perform a refresh operation of data in the macro 220 of the L2 cache 140, the system is going to have to pay a power cost to read and write data as part of performing the refresh operation.

The system 110 of this disclosure takes advantage of the moment that the data is being read and written during the refresh operation and determines whether there is data in the L3 prefetch queue 270 that is set to be supplied to the word line undergoing the refresh. If there is no data in the L3 prefetch queue 270 that is to be supplied to the word line, then the refresh write-in signal is non-enabled and the refresh operation occurs on the existing data. If the address of the word line containing the refreshed data matches with the address of any word line of data in the L1 prefetch queue 260, then the refresh-read-out signal is enabled and this data is sent to the L1 cache 130. On the other hand, if the address of the word line of this refreshed data is not a match with any address of the data in the L1 prefetch queue 260, then the refresh-read-out signal is non-enabled and the existing data is refreshed locally within the macro 220 of the L2 cache. This approach reduces the power cost of transferring data to the L1 cache 130 and increases performance by obviating stalling of the CPU 120 that would occur if the CPU had to search through the various levels of the cache 110 to find particular data.

The components within the L2 cache 140 are applicable within the L1 cache 130 and the L3 cache 150. As mentioned above, the functionality of the eDRAM cache in each cache level will vary depending on where it is situated within the hierarchy of the cache. For example, if the eDRAM cache is located in the L1 cache, then the refresh controller in this cache would only assert a refresh write-in signal and not a refresh read-out signal. Therefore, in this embodiment there would be only an L2 prefetch queue. If the eDRAM cache is located in the L3 cache, then the refresh controller in this cache would only assert a refresh read-out signal and not a refresh write-in signal because the L3 cache is only reading pending data to the L2 cache. Therefore, in this embodiment there would be only an L2 prefetch queue for reading data to the L2 cache.

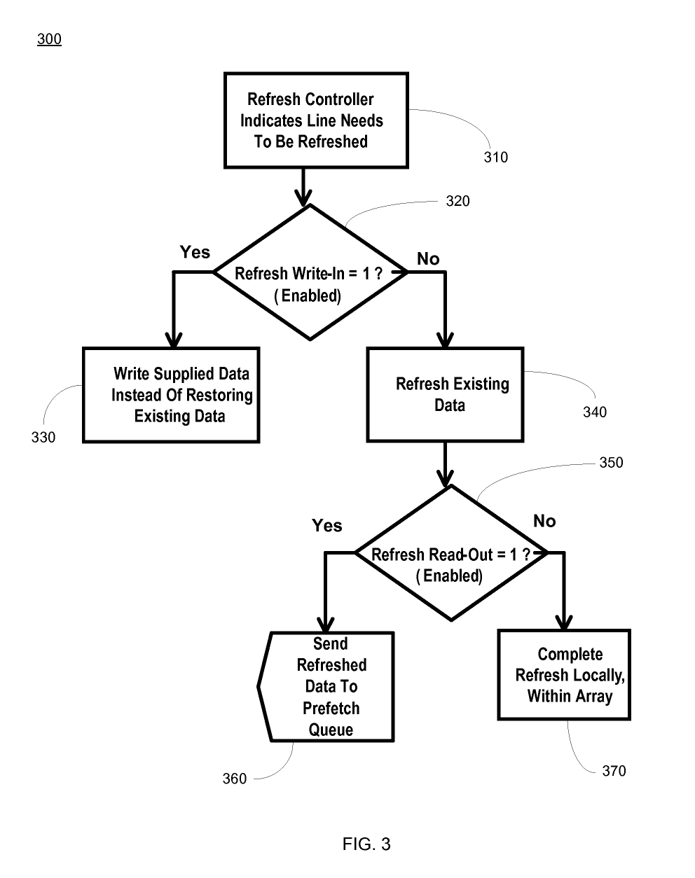

FIG. 3 is a flow chart describing a process 300 of performing a refresh operation with the multi-level cache memory system 110 shown in FIG. 1 according to one embodiment of this disclosure. The process 300 begins at 310 where the refresh controller 230 within the macro 220 indicates that a particular word line within the macro needs to be refreshed. The refresh controller determines whether the refresh write-in signal has been enabled at 320. In one embodiment, the refresh write-in signal is enabled if it is set to one. As mentioned above, a refresh write-in signal that is enabled is indicative that there is an address in a pending prefetch queue (e.g., L3 prefetch queue) that contains data to be supplied to the macro that matches the address of the word line scheduled to be refreshed. If the refresh write-in signal is enabled as determined at 320, then the data from the lower level prefetch queue is supplied to the word line at 330 as opposed to refreshing the existing data.

Alternatively, if the refresh write-in signal is non-enabled (i.e., not equal to 1) as determined at 320, then the existing data in the word line of the macro that is scheduled for a refresh operation is refreshed at 340. To facilitate reduced power consumption and improved performance, the refresh controller 230 determines at 350 whether the refresh read-out signal has been enabled (i.e., set to 1). As mentioned above, a refresh read-out signal that is enabled is indicative that the refreshed data may be useful to a higher level cache (e.g., the L1 cache) sometime in the future. Thus, if the refresh read-out signal is enabled, the refresh controller sends it to the higher level prefetch queue (e.g., L1 prefetch queue) at 360. On the other hand, if the refresh read-out signal is non-enabled (i.e., not equal to 1) as determined at 350 then the refresh operation is completed at 370. More specifically, the existing data is refreshed locally within the macro of the specific cache level (e.g., macro 220 of the L2 cache 140).

The foregoing flow chart of FIG. 3 shows some of the functions associated with performing a refresh operation with the multi-level cache memory system 110. In this regard, each block represents an act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe the functions may be added.

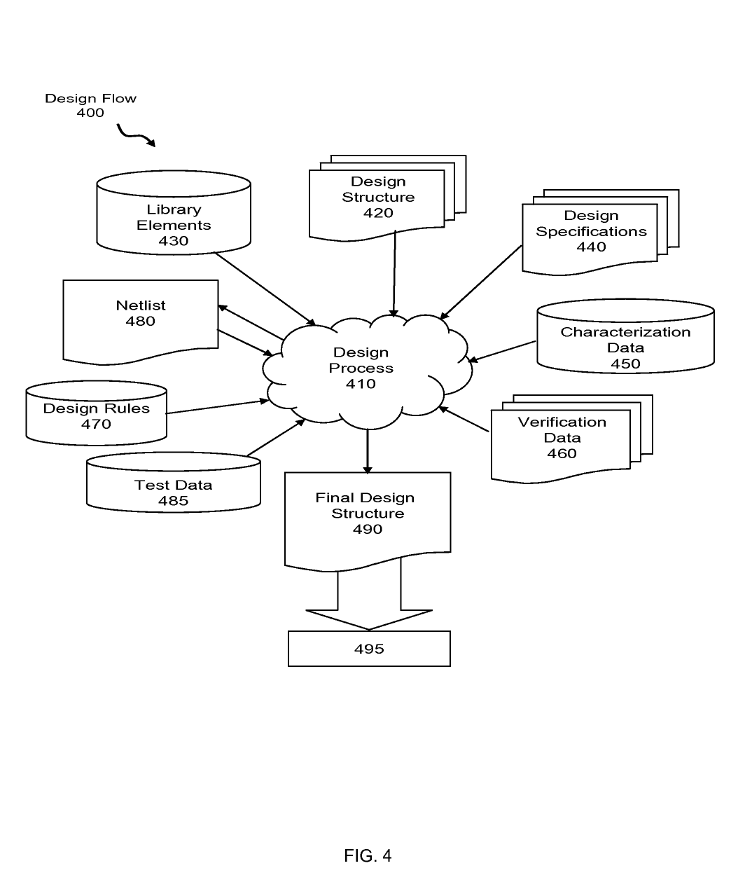

FIG. 4 shows a block diagram of an exemplary design flow 400 used for example, in semiconductor design, manufacturing, and/or test. Design flow 400 may vary depending on the type of IC being designed. For example, a design flow 400 for building an application specific IC (ASIC) may differ from a design flow 400 for designing a standard component or from a design from 400 for instantiating the design into a programmable array, for example a programmable gate array (PGA) or a field programmable gate array (FPGA) offered by Altera® Inc. or Xilinx® Inc. Design structure 420 is preferably an input to a design process 410 and may come from an IP provider, a core developer, or other design company or may be generated by the operator of the design flow, or from other sources. Design structure 420 comprises an embodiment of the disclosure as shown in FIGS. 1 and 2 in the form of schematics or HDL, a hardware-description language (e.g., Verilog, VHDL, C, etc.). Design structure 420 may be contained on one or more machine readable medium. For example, design structure 420 may be a text file or a graphical representation of an embodiment of the disclosure as shown in FIGS. 1 and 2. Design process 410 preferably synthesizes (or translates) an embodiment of the disclosure as shown in FIGS. 1 and 2 into a netlist 480, where netlist 480 is, for example, a list of wires, transistors, logic gates, control circuits, I/O, models, etc. that describes the connections to other elements and circuits in an integrated circuit design and recorded on at least one of machine readable medium. For example, the medium may be a CD, a compact flash, other flash memory, a packet of data to be sent via the Internet, or other networking suitable means. The synthesis may be an iterative process in which netlist 480 is resynthesized one or more times depending on design specifications and parameters for the circuit.

Design process 410 may include using a variety of inputs; for example, inputs from library elements 430 which may house a set of commonly used elements, circuits, and devices, including models, layouts, and symbolic representations, for a given manufacturing technology (e.g., different technology nodes, 32 nm, 45 nm, 90 nm, etc.), design specifications 440, characterization data 450, verification data 460, design rules 470, and test data files 485 (which may include test patterns and other testing information). Design process 410 may further include, for example, standard circuit design processes such as timing analysis, verification, design rule checking, place and route operations, etc. One of ordinary skill in the art of integrated circuit design can appreciate the extent of possible electronic design automation tools and applications used in design process 410 without deviating from the scope and spirit of the disclosure. The design structure of the disclosure is not limited to any specific design flow.

Design process 410 preferably translates an embodiment of the disclosure as shown in FIGS. 1 and 2, along with any additional integrated circuit design or data (if applicable), into a second design structure 490. Design structure 490 resides on a storage medium in a data format used for the exchange of layout data of integrated circuits and/or symbolic data format (e.g. information stored in a GDSII (GDS2), GL1, OASIS, map files, or any other suitable format for storing such design structures). Design structure 490 may comprise information such as, for example, symbolic data, map files, test data files, design content files, manufacturing data, layout parameters, wires, levels of metal, vias, shapes, data for routing through the manufacturing line, and any other data required by a semiconductor manufacturer to produce an embodiment of the disclosure as shown in FIGS. 1 and 2. Design structure 490 may then proceed to a stage 495 where, for example, design structure 490: proceeds to tape-out, is released to manufacturing, is released to a mask house, is sent to another design house, is sent back to the customer, etc.

It is apparent that there has been provided with this disclosure a design structure for an eDRAM having multi-use refresh cycles. While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A design structure embodied in a machine readable medium used in a design process, the design structure, comprising:
a pending write queue configured to receive write operations from at least one of the levels of cache; and
a refresh controller configured to determine addresses within the cache that are due for a refresh, wherein the refresh controller is configured to assert a refresh write-in signal to write data supplied from the pending write queue specified for an address due for a refresh rather than refresh existing data, the refresh controller asserts the refresh write-in signal in response to a determination that there is pending data to supply to the address specified to have the refresh, the refresh controller further configured to assert a refresh read-out signal to send refreshed data to a prefetch queue of a higher level of cache as a prefetch operation in response to a determination that the refreshed data is useful.

2. The design structure of claim 1, wherein the design structure comprises a netlist.

3. The design structure of claim 1, wherein the design structure resides on storage medium as a data format used for the exchange of layout data of integrated circuits.

4. The design structure of claim 1, wherein the design structure resides in a programmable gate array.

5. The design structure according to claim 1, wherein the refresh controller raises the refresh write-in signal to an enabled state to indicate that there is pending data to supply to the address specified to have the refresh.

6. The design structure according to claim 1, wherein the refresh controller raises the refresh read-out signal to an enabled state in response to a determination that the refreshed data is useful.

7. The design structure according to claim 1, further comprising a pending read queue configured to receive read requests from at least one of the levels of cache.

8. The design structure according to claim 1, wherein the pending write queue is configured to receive pending prefetch operations from at least one of the levels of cache.
